(19) United States
(12) Patent Application Publication
(10) Pub. No.: US 2025/0249565 A1
(43) Pub. Date: Aug. 7, 2025

(54) Anchor Drive Adapter Tool

(71) Applicant: Steven L Wojtaszek, Midland, MI (US)

(72) Inventor: Steven L Wojtaszek, Midland, MI (US)

(21) Appl. No.: 19/043,625

(22) Filed: Feb. 3, 2025

Related U.S. Application Data
(60) Provisional application No. 63/549,472, filed on Feb. 3, 2024.

(51) Int. Cl. B25F 3/00; E04B 1/343

(52) U.S. Cl. CPC B25F 3/00; E04B 1/34347

(57) ABSTRACT

A device which allows a structural earth anchor to be adapted to allow a standard connection to commonly available powered rotary tools.

### BACKGROUND OF THE INVENTION

A common device for securing structures to their surroundings is the ground (earth) anchor as shown in FIGS. 1 and 2 as items 1 and 2. Earth anchors are one recommended method of securing portable dwelling structures (some of which are also known as “mobile homes”) and these anchors can be referred to as “mobile home anchors.” Many designs of mobile home anchors are of the helical types which require the anchors to be installed by rotating them into the medium (typically earth ground) to function. This rotation can be accomplished with a lever traditionally in the form of a steel bar or wood member which connects to the top of the anchor allowing a user to install the anchor with human effort (by hand) for anchors and ground condition combinations which afford this method.

In the case of anchors used for securing structures such as mobile homes a common design incorporates a provision to attach steel strapping from the anchor head to the structure. This design also allows for the insertion of a typical wood “2×4” which can be used as a lever to rotate and install the anchor into the desired location.

While this “manual” method to install anchors is effective, a less physically demanding and more time efficient option to the installer is to drive the anchors in with a commonly available powered tool such as an impact wrench, drill, or other powered rotating equipment or even a tool that does not need to be removed to be continued to be used such as with a ratchet wrench. These methods will be collectively referred to in other parts of this document as “prime movers.”

In order to maintain the ultimate design intention of the anchor to utilize strapping material to connect to the structure, and to accommodate the many anchors already in existence which may need to be reclaimed or reused, an adapter tool can be constructed which allows a user to connect to the anchor head while also providing a standard connection to prime movers as described in [003].

The objective of the anchor adapter tool is to afford the installer the ability to temporarily connect to anchors which do not already have the ability to support standard connections such as those commonly available on rotary powered tools. Once the anchor is installed using the adapter tool, it can be removed to utilize the anchor in its intended fashion.

The adapter tool is constructed in a way as to provide a concentric connection between the rotary power source output and the anchor shaft. That is, variations of the tool accommodate different styles of anchor heads, but in each case the adapter provides a concentric connection between the rotary power source and the anchor shaft to minimize the negative effects of an eccentric connection. FIGS. 2 and 3 are typical examples of mobile home anchors having different head placements relative to each respective anchor shaft. The adapter is constructed to account for these differences to maintain concentric alignment of the prime mover output to the anchor shaft. This minimizes “wobble” of the assembly during installation and the associated deficiencies caused by misalignment such as reduced effective torque transmission into the anchor and excessive lateral movement of the assembly among possibly other deficiencies.

Further benefits include being compact, lightweight, and having a low profile which allows the tool to be easily placed into and removed from the anchor even if it is in a location which would make larger components difficult to place in and take out of the anchor.

### SUMMARY OF THE INVENTION

In its very basic form, the anchor adapter in centered 7 and offset versions 8 consists of a rigid frame 3 capable of withstanding the anticipated loading and able to be fixed to the anchor using screws, pins, or other typical connecting methods. The anchor adapter is equipped with standard drive connections which allows installers to choose the preferred driving equipment to be used such as those mentioned in [003].

The adapter tool could be used both in an impacting and non-impacting fashion with appropriate design capabilities and provisions for each.

### BRIEF DESCRIPTION OF THE DRAWINGS

FIG. 1 depicts a typical mobile home anchor with an anchor shaft centered to its connection head at the top of the drawing.

FIG. 2 depicts a typical mobile home anchor with an anchor shaft offset to its connection head at the top of the drawing.

FIG. 3 is the general layout of the centered version of the tool which would connect to a typical mobile home anchor with a centered connection head.

FIG. 3A Centered mobile home anchor adapter top

FIG. 3B Centered mobile home anchor adapter side view

FIG. 3C Centered mobile home anchor adapter end view

FIG. 3D Centered mobile home anchor adapter bottom view

FIG. 3E Centered mobile home anchor adapter isometric view

FIG. 4 is the general layout of the offset version of the tool which would connect to a typical mobile home anchor with a offset connection head.

FIG. 4A Offset mobile home anchor adapter top

FIG. 4B Offset mobile home anchor adapter side view

FIG. 4C Offset mobile home anchor adapter end view

FIG. 4D Offset mobile home anchor adapter bottom view

FIG. 4E Offset mobile home anchor adapter isometric view

FIG. 5 is a typical mobile home anchor with a centered head with the centered adapter tool inserted.

FIG. 6 is a typical mobile home anchor with a offset head with the offset adapter tool inserted.

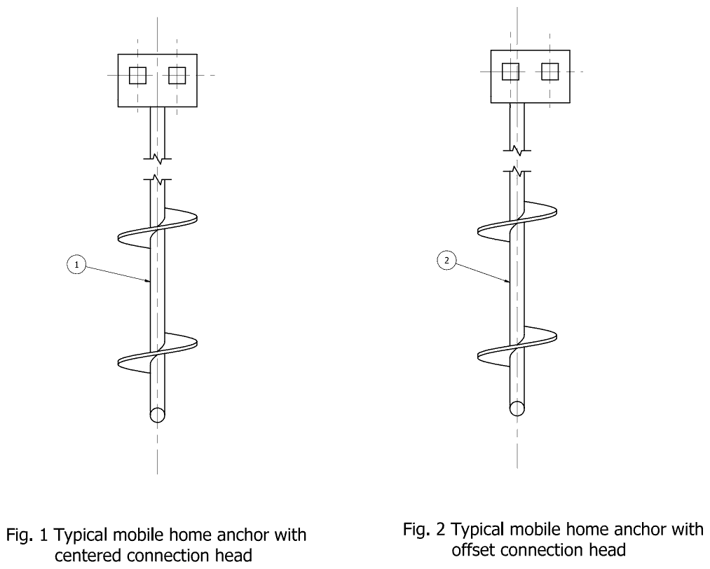

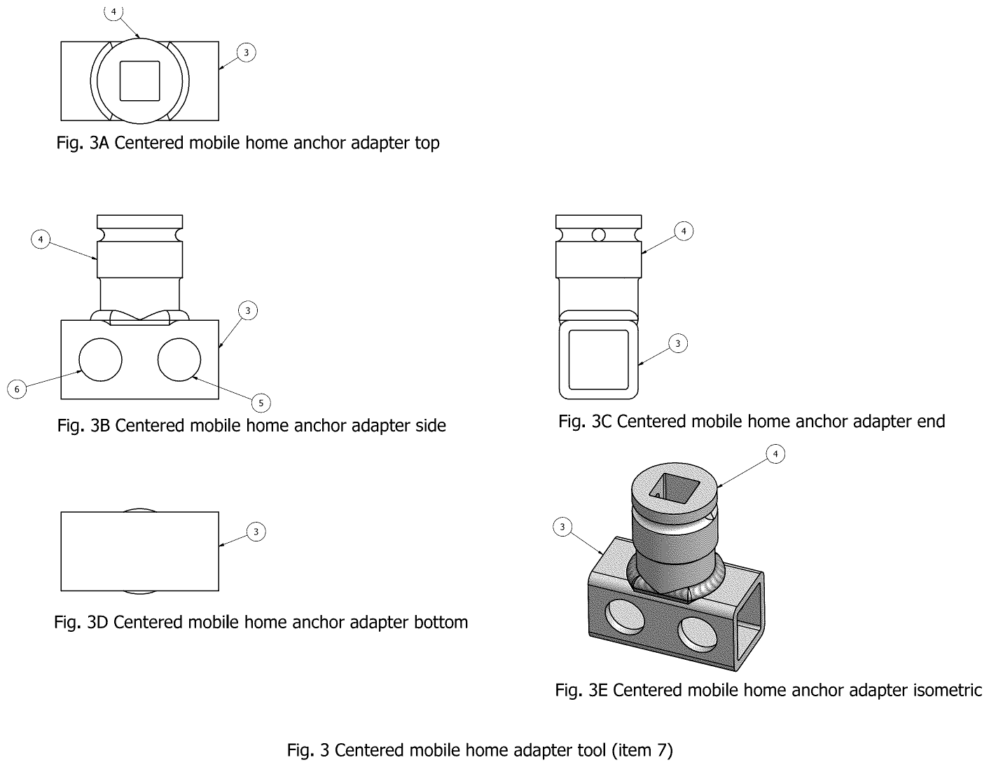

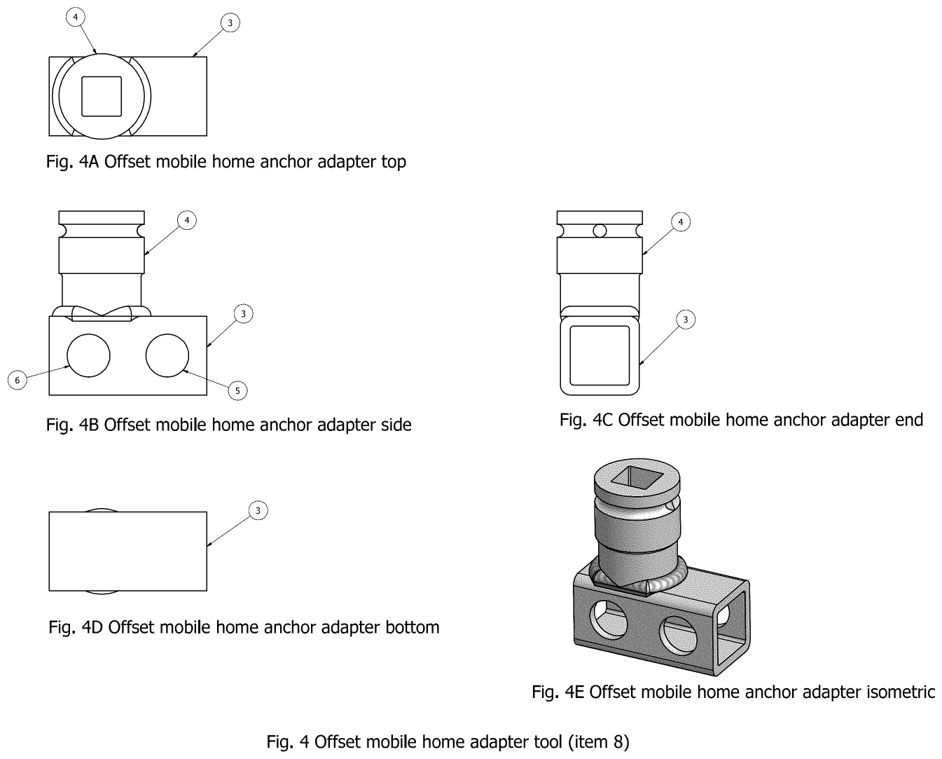

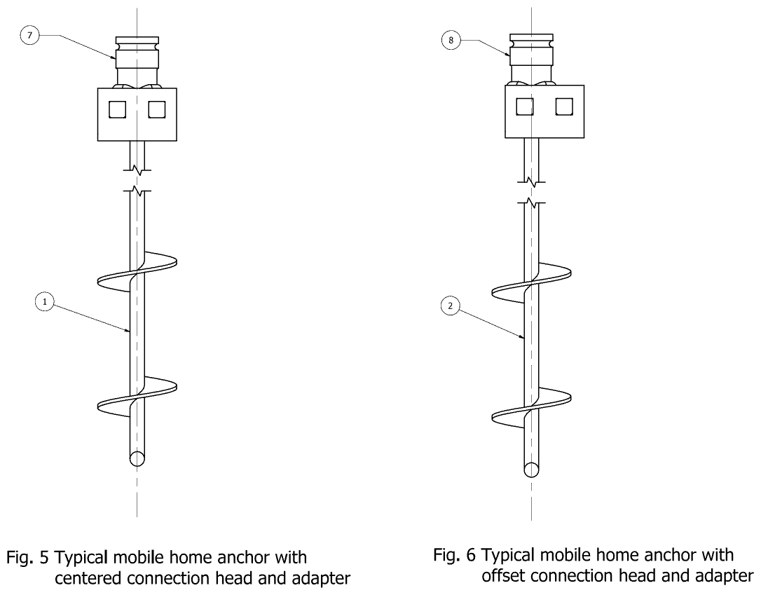

### DETAILED DESCRIPTION OF THE PREFERRED EMBODIMENT

The preferred embodiment consists of a frame constructed of material of sufficient strength such a low carbon steel or steels with additives to develop resistance to failure from fatigue from impact or high stresses. The unit is either a weldment of components to achieve the desired strength and input connection or one continuous cast or forged piece resulting in the same.

The frame 3 of the adapter tool is comprised of two lateral through holes 5 and 6 in a square tubular or solid structure, matching the positions of the anchor head provisions for screws or pins and allowing said screws or pins to pass from one side of the anchor head and through it to the other side where they can be secured with nuts or locking pins.

Perpendicularly positioned and attached to the frame is the connection for the prime mover 4 which is additionally positioned to provide a concentric axial connection between the prime mover output and the shaft of the anchor. This connection can be either welded or formed as a casting or forging of a single piece to achieve the same result.

1. A mobile home anchor adapter tool comprising provisions to connect to a mobile home anchor and allowing a prime mover to be connected to it with a commonly available standard connection type.
The device of claim 1, wherein the standard common connection is of the square, hexagonal, or round shaft types for use with prime movers equipped with the same.
The device of claim 1, wherein the square member has hole(s) in it matching the positions of those in the mobile home anchor affording screws or pins to be placed through the tool and secured to attach the tool to the anchor.
The device of claims 3 and 4, wherein the tool provides a concentric connection between the longitudinal axis of prime mover output connection and the longitudinal axis of the anchor shaft.
